(19) United States
(12) Patent Application Publication
(10) Pub. No.: US 2025/0234439 A1
(43) Pub. Date: Jul. 17, 2025

(54) LIGHTING DEVICE WITH AN ADAPTIVE ADJUSTMENT MECHANISM

(71) Applicant: Xiamen PVTECH Co., Ltd., Xiamen (CN)

(72) Inventors: Zhirong LIN, Xiamen (CN); Zhentao LI, Xiamen (CN); Fuxing LU, Xiamen (CN)

(73) Assignee: Xiamen PVTECH Co., Ltd., Xiamen (CN)

(21) Appl. No.: 19/014,251

(22) Filed: Jan. 9, 2025

(30) Foreign Application Priority Data
Jan. 12, 2024 (CN) 202410049470.0

(51) Int. Cl. H05B 45/355; H05B 45/50

(52) U.S. Cl. CPC H05B 45/355; H05B 45/50

(57) ABSTRACT

A lighting device includes a light source module, a rectification module, a power supply module, a detection module and a control module. The rectification module generates a rectified voltage. The power supply module is connected to the rectification module and the light source module, and includes a power factor correction unit and a voltage conversion unit. The power supply module receives the rectified voltage to generate a driving voltage so as to drive the light source module. The detection module is connected to the power supply module, and includes a first detection unit for detecting the power factor correction unit and a second detection unit for detecting the voltage conversion unit. The control module is connected to the detection module, and includes a backup power unit. The control module controls the backup power unit according to the detection results of the first detection unit and the second detection unit.

### BACKGROUND OF THE INVENTION

### 1. Field of the Invention

The present invention relates to a lighting device, in particular to a lighting device with an adaptive adjustment mechanism.

### 2. Description of the Prior Art

In the field of industrial lighting, there has always been a significant demand for high-reliability lighting devices. To achieve high reliability, these lighting devices often employ expensive electronic components. However, even when the service life of the electronic components is sufficiently long, abnormal operating conditions of these components remain the primary cause of lighting device failures.

For most electronic components, the cost increases exponentially as they meet higher parameter requirements. Additionally, due to limitations in manufacturing processes, these electronic components inherently possess certain parasitic parameters, which adversely affect circuit performance. Addressing the issues caused by these parasitic parameters requires additional adjustments, increasing maintenance costs and system complexity while also raising the probability of lighting device failures.

Moreover, enhancing a single parameter often results in larger component sizes, making it difficult to integrate with existing products and further increasing the development cost of lighting devices.

China Patent Publication No.: CN115515279A and China Patent No.: CN217936004U discloses improved circuit designs, but these circuit designs still fail to effectively resolve the above problems.

### SUMMARY OF THE INVENTION

One embodiment of the present invention provides a lighting device with an adaptive adjustment mechanism, which includes a light source module, a rectification module, a power supply module, a detection module and a control module. The rectification module generates a rectified voltage. The power supply module is connected to the rectification module and the light source module, and includes a power factor correction unit and a voltage conversion unit. The power supply module receives the rectified voltage to generate a driving voltage so as to drive the light source module. The detection module is connected to the power supply module, and includes a first detection unit for detecting the power factor correction unit and a second detection unit for detecting the voltage conversion unit. The control module is connected to the detection module, and includes a backup power unit. The control module controls the backup power unit according to the detection result of the first detection unit and the second detection unit.

In one embodiment, the control module activates the backup power unit to drive the light source module when the second detection unit detects that the voltage conversion unit is abnormal.

In one embodiment, the light source module includes a main light source, a first backup light source, and a second backup light source.

In one embodiment, the control module does not activate the backup power unit when the first detection unit detects that the power factor correction unit is normal and the second detection unit detects that the voltage conversion unit is normal, and drives the main light source via the power factor correction unit and the voltage conversion unit.

In one embodiment, the control module does not activate the backup power unit when the first detection unit detects that the power factor correction unit is abnormal and the second detection unit detects that the voltage conversion unit is normal, and drives the main light source via the voltage conversion unit.

In one embodiment, the control module activates the backup power unit when the first detection unit detects that the power factor correction unit is normal and the second detection unit detects that the voltage conversion unit is abnormal, and drives the main light source, the first backup light source, and the second backup light source via the voltage conversion unit and the backup power unit.

In one embodiment, the control module activates the backup power unit when the first detection unit detect that the power factor correction unit is abnormal and the second detection unit detects that the voltage conversion unit is abnormal, and drives the main light source and the first backup light source via the backup power unit.

In one embodiment, the power factor correction unit includes a first protection element, and the first protection element enters the disconnected state when the power factor correction unit is abnormal.

In one embodiment, the voltage conversion unit comprises a second protection element, and the second protection element enters the disconnected state when the voltage conversion unit is abnormal.

In one embodiment, the first protection element and the second protection element are fuses.

The lighting device with the adaptive adjustment mechanism in accordance with the embodiments of the present invention may have the following advantages:
(1) In one embodiment of the present invention, the lighting device includes a light source module, a rectification module, a power supply module, a detection module and a control module. The rectification module generates a rectified voltage. The power supply module is connected to the rectification module and the light source module, and includes a power factor correction unit and a voltage conversion unit. The power supply module receives the rectified voltage to generate a driving voltage so as to drive the light source module. The detection module is connected to the power supply module, and includes a first detection unit for detecting the power factor correction unit and a second detection unit for detecting the voltage conversion unit. The control module is connected to the detection module, and includes a backup power unit. The control module controls the backup power unit according to the detection result of the first detection unit and the second detection unit. Via the above-mentioned adaptive adjustment mechanism, the lighting device can maintain a constant output power even in the event of a power supply module malfunction, thereby reducing the failure rate of the lighting device. As a result, the reliability of the lighting device can be effectively improved so as to meet actual requirements.
(2) In one embodiment of the present invention, the light source module includes a main light source, a first backup light source, and a second backup light source. The control module can detect the operational status of the power factor correction unit via the first detection unit and detect the operational status of the voltage conversion unit via the second detection unit. Then, the control module can control the backup power unit according to the detection results of the first detection unit and the second detection unit in order to selectively drive one or more of the main light source, the first backup light source, and the second backup light source. The above-mentioned adaptive adjustment mechanism can ensure constant output power via a simple operational mechanism. Consequently, the circuit complexity of the lighting device can be effectively reduced.
(3) In one embodiment of the present invention, the lighting device can ensure constant output power through a simple and effective adaptive adjustment mechanism, thereby significantly improving the reliability of the lighting device and greatly reducing its circuit complexity. As a result, the maintenance cost of the lighting device can be substantially reduced, such that the lighting device can conform to the requirements of different applications.
(4) In one embodiment of the present invention, the adaptive adjustment mechanism of the lighting device can be applied to the circuit design of currently available lighting devices, thus achieving high compatibility. Additionally, the adaptive adjustment mechanism of the lighting device can be implemented without increasing the size of the electronic components. As a result, the development cost of the lighting device can also be effectively reduced.
(5) In one embodiment of the present invention, the adaptive adjustment mechanism of the lighting device can selectively drive one or more of the main light source, the first backup light source, and the second backup light source according to the operational status of the power supply module. Thus, with appropriate load design, the lighting device can maintain constant output power to achieve high operational efficiency. As a result, the lighting device can be more energy-efficient, which can align with environmental protection needs.
(6) In one embodiment of the present invention, the lighting device can achieve the desired functionality without significantly increasing costs and can effectively address the shortcomings of currently available technologies. Therefore, the lighting device can achieve high practicality in order to meet the needs of different users.

Further scope of applicability of the present application will become more apparent from the detailed description given hereinafter.

However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a lighting device with an adaptive adjustment mechanism in accordance with a first embodiment of the present invention.

FIG. 2 is a circuit diagram of a lighting device with an adaptive adjustment mechanism in accordance with a second embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

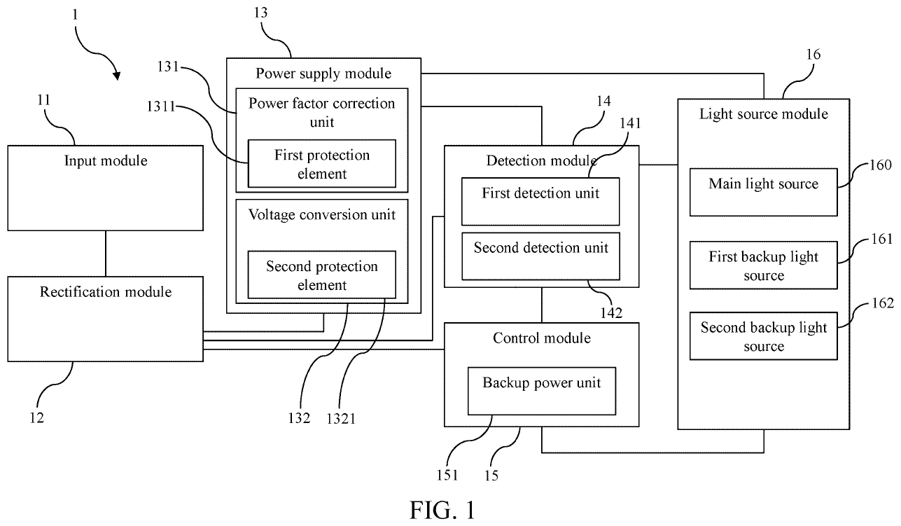

Please refer to FIG. 1, which is a block diagram of a lighting device with an adaptive adjustment mechanism in accordance with a first embodiment of the present invention. As shown in FIG. 1, the lighting device 1 includes an input module 11, a rectification module 12, a power supply module 13, a detection module 14, a control module 15, and a light source module 16.

The input module 11 is connected to an external power source and receives an input voltage from the external power source. In one embodiment, the external power source may be a utility power, a generator, or other similar power sources.

The rectification module 12 is connected to the input module 11 and converts the input voltage to generate a rectified voltage. In one embodiment, the rectification module 12 may include a full-wave rectifier. In another embodiment, the rectification module 12 may include a half-wave rectifier or other similar components.

The power supply module 13 is connected to the rectification module 12. The power supply module 13 may include a power factor correction unit 131 and a voltage conversion unit 132. The power supply module 13 receives the rectified voltage to generate a driving voltage. In one embodiment, the power factor correction unit 131 may be an active power factor correction circuit (APFC). In another embodiment, the voltage conversion unit 132 may be a buck converter, a boost converter, a buck-boost converter, a flyback converter, or other similar components. The circuit structure of the power supply module 13 should be well-known to those skilled in the art and will not be further detailed here. Unlike currently available power supply modules, the power factor correction unit 131 includes a first protection element 1311, while the voltage conversion unit 132 includes a second protection element 1321. In one embodiment, the first protection element 1311 and the second protection element 1321 may be fuses or other components with circuit protection functions.

The detection module 14 is connected to the rectification module 12 and the power supply module 13 and includes a first detection unit 141 and a second detection unit 142. The first detection unit 141 is used to detect the power factor correction unit 131, while the second detection unit 142 is used to detect the voltage conversion unit 132.

The control module 15 is connected to the rectification module 12 and the detection module 14. The control module 15 includes a backup power unit 151. The control module 15 controls the backup power unit 151 according to the detection results of the first detection unit 141 and the second detection unit 142.

The light source module 16 is connected to the power supply module 13, the detection module 14, and the control module 15. The light source module 16 includes a main light source 160, a first backup light source 161, and a second backup light source 162. In one embodiment, the main light source 160 may be a light-emitting diode (LED) or include multiple LEDs connected in series or parallel. Additionally, the main light source 160 may simultaneously include both series and parallel circuits. In another embodiment, the main light source 160 may be an LED array or other similar components. The structures of the first backup light source 161 and the second backup light source 162 may be identical to or different from that of the main light source 160.

When the first detection unit 141 detects that the power factor correction unit 131 is normal and the second detection unit 142 detects that the voltage conversion unit 132 is normal, the control module 15 does not activate the backup power unit 151. At this time, the power supply module 13 operates normally, driving the main light source 160 via the power factor correction unit 131 and the voltage conversion unit 132. At this time, the voltage of the main light source 160 is Va, and the current is Ia. The voltage (load voltage) of the main light source 160 is close to the voltage of the main output wire (the wire which the rectification module 12 outputs the rectified voltage) of the rectification module 12, effectively reducing circuit loss and ensuring that the total output power is substantially equal to the preset power. This allows the lighting device 1 to maintain constant output power.

When the power factor correction unit 131 malfunctions, the first protection element 1311 enters the disconnected state, and the first detection unit 141 can detect that the power factor correction unit 131 is abnormal. If the power factor correction unit 131 is malfunctioning but the voltage conversion unit 132 is functioning normally, the control module 15 does not activate the backup power unit 151. At this time, the power supply module 13 functions as a low power factor single-stage buck circuit and drives the main light source 160 via the voltage conversion unit 132. If the voltage (load voltage) of the main light source 160 is less than the voltage of the main output wire of the rectification module 12, the voltage of the main light source 160 is Va, and the current is Ia, ensuring that the total output power remains substantially equal to the preset power. In this way, the lighting device 1 can maintain constant output power.

When the voltage conversion unit 132 malfunctions, the second protection element 1321 enters the disconnected state, and the second detection unit 142 can detect that the voltage conversion unit 132 is abnormal. If the power factor correction unit 131 is functioning normally but the voltage conversion unit 132 is malfunctioning, the control module 15 activates the backup power unit 151. At this time, the voltage conversion unit 132 and the backup power unit 151 simultaneously drive the main light source 160, the first backup light source 161, and the second backup light source 162. The voltage of the main light source 160 is Va, and the current is Ia. The voltage of the first backup light source 161 is Vb, and the current is Ib. The voltage of the second backup light source 162 is Vc, and the current is Ic. With appropriate load design, the load voltage Vp is effectively equal to the total voltage of the main light source 160, the first backup light source 161, and the second backup light source 162 (Va+Vb+Vc), which approaches the voltage of the main output wire of the rectification module 12. This effectively reduces circuit loss and ensures that the total output power is substantially equal to the preset power. As such, the lighting device 1 can maintain constant output power.

When both the power factor correction unit 131 and the voltage conversion unit 132 malfunction, the first protection element 1311 and the second protection element 1321 both enter the disconnected state, and the first detection unit 141 and the second detection unit 142 can respectively detect that the power factor correction unit 131 and the voltage conversion unit 132 are abnormal. Under these conditions, the control module 15 activates the backup power unit 151, which drives the main light source 160 and the first backup light source 161. The voltage of the main light source 160 is Va, and the current is Ia. The voltage of the first backup light source 161 is Vb, and the current is Ib. Through appropriate load design, the load voltage Vp is effectively equal to the total voltage of the main light source 160 and the first backup light source 161 (Va+Vb), which approaches the voltage of the main output wire of the rectification module 12. This reduces circuit loss and ensures that the total output power is substantially equal to the preset power. Thus, the lighting device 1 can maintain constant output power.

Therefore, the control module 15 can appropriately control the backup power unit 151 based on the operational state of the power supply module 13 and selectively drive the main light source 160, the first backup light source 161, and the second backup light source 162 to ensure that the load voltage approaches the voltage of the main output wire of the rectification module 12. In this manner, the lighting device 1 can maintain constant output power.

As outlined above, the control module 15 controls the backup power unit 151 based on the detection results of the first detection unit 141 and the second detection unit 142. With the described adaptive adjustment mechanism, the lighting device 1 can maintain constant output power even when the power supply module 13 malfunctions, reducing the failure rate of the lighting device 1. This effectively improves the reliability of the lighting device 1 so as to meet actual requirements.

Furthermore, the light source module 16 includes the main light source 160, the first backup light source 161, and the second backup light source 162. The control module 15 can detect the operational state of the power factor correction unit 131 via the first detection unit 141 and detect the operational state of the voltage conversion unit 132 via the second detection unit 142. The control module 15 can then control the backup power unit 151 according to the detection results of the first detection unit 141 and the second detection unit 142, selectively driving one or more of the main light source 160, the first backup light source 161, and the second backup light source 162. The described adaptive adjustment mechanism ensures output power constant with a simplified operational mechanism. This effectively reduces the circuit complexity of the lighting device 1. Additionally, the reliability of the lighting device 1 is significantly enhanced, while the circuit complexity thereof is greatly reduced.

Moreover, as described above, the adaptive adjustment mechanism of the lighting device 1 can selectively drive one or more of the main light source 160, the first backup light source 161, and the second backup light source 162 based on the operational state of the power supply module 13. Consequently, through appropriate load design, the lighting device 1 can maintain constant output power, achieving high operational efficiency. Thus, the lighting device 1 is more energy-efficient and environmentally friendly so as to conform to environmental protection needs.

The embodiment just exemplifies the present invention and is not intended to limit the scope of the present invention; any equivalent modification and variation according to the spirit of the present invention is to be also included within the scope of the following claims and their equivalents.

It is worthy to point out that the reliability of currently available lighting devices is low, and their system complexity increases both maintenance costs and the likelihood of failure. Besides, the compatibility of these lighting devices requires further improvement. By contrast, according to one embodiment of the present invention, one embodiment of the present invention, the lighting device includes a light source module, a rectification module, a power supply module, a detection module and a control module. The rectification module generates a rectified voltage. The power supply module is connected to the rectification module and the light source module, and includes a power factor correction unit and a voltage conversion unit. The power supply module receives the rectified voltage to generate a driving voltage so as to drive the light source module. The detection module is connected to the power supply module, and includes a first detection unit for detecting the power factor correction unit and a second detection unit for detecting the voltage conversion unit. The control module is connected to the detection module, and includes a backup power unit. The control module controls the backup power unit according to the detection result of the first detection unit and the second detection unit. Via the above-mentioned adaptive adjustment mechanism, the lighting device can maintain a constant output power even in the event of a power supply module malfunction, thereby reducing the failure rate of the lighting device. As a result, the reliability of the lighting device can be effectively improved so as to meet actual requirements.

According to one embodiment of the present invention, the light source module includes a main light source, a first backup light source, and a second backup light source. The control module can detect the operational status of the power factor correction unit via the first detection unit and detect the operational status of the voltage conversion unit via the second detection unit. Then, the control module can control the backup power unit according to the detection results of the first detection unit and the second detection unit in order to selectively drive one or more of the main light source, the first backup light source, and the second backup light source. The above-mentioned adaptive adjustment mechanism can ensure constant output power via a simple operational mechanism. Consequently, the circuit complexity of the lighting device can be effectively reduced.

Also, according to one embodiment of the present invention, the lighting device can ensure constant output power through a simple and effective adaptive adjustment mechanism, thereby significantly improving the reliability of the lighting device and greatly reducing its circuit complexity. As a result, the maintenance cost of the lighting device can be substantially reduced, such that the lighting device can conform to the requirements of different applications.

Further, according to one embodiment of the present invention, the adaptive adjustment mechanism of the lighting device can be applied to the circuit design of currently available lighting devices, thus achieving high compatibility. Additionally, the adaptive adjustment mechanism of the lighting device can be implemented without increasing the size of the electronic components. As a result, the development cost of the lighting device can also be effectively reduced.

Moreover, according to one embodiment of the present invention, the adaptive adjustment mechanism of the lighting device can selectively drive one or more of the main light source, the first backup light source, and the second backup light source according to the operational status of the power supply module. Thus, with appropriate load design, the lighting device can maintain constant output power to achieve high operational efficiency. As a result, the lighting device can be more energy-efficient, which can align with environmental protection needs.

Furthermore, according to one embodiment of the present invention, the lighting device can achieve the desired functionality without significantly increasing costs and can effectively address the shortcomings of currently available technologies. Therefore, the lighting device can achieve high practicality in order to meet the needs of different users. As set forth above, the lighting device with the adaptive adjustment mechanism according to the embodiments of the present invention can achieve great technical effects.

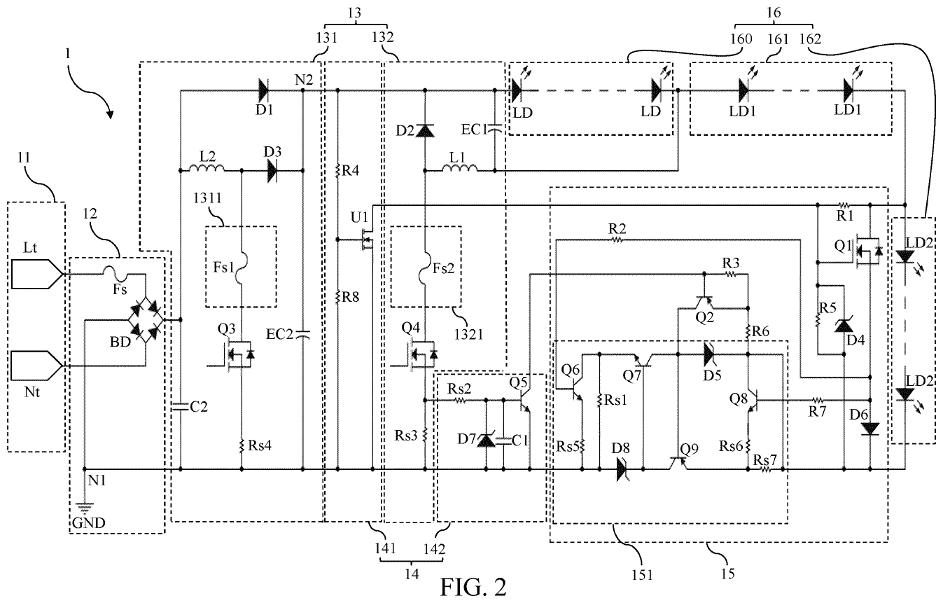

Please refer to FIG. 2, which is a circuit diagram of a lighting device with an adaptive adjustment mechanism in accordance with a second embodiment of the present invention. As shown in FIG. 2, the lighting device 1 comprises an input module 11, a rectification module 12, a power supply module 13, a detection module 14, a control module 15, and a light source module 16.

The input module 11 is connected to an external power source and includes a live wire input terminal Lt and a neutral wire input terminal Nt.

The rectification module 12 is connected to the input module 11 and includes a fuse Fs and a rectifier BD. The two input terminals of the rectification module 12 are connected to the live wire input terminal Lt and the neutral wire input terminal Nt, respectively, while the two output terminals of the rectification module 12 are connected to the power supply module 13 and the first node N1, respectively. The first node N1 is connected to the grounding point GND.

The power supply module 13 may include a power factor correction unit 131 and a voltage conversion unit 132. The power factor correction unit 131 is connected to the rectification module 12, the first node N1, and the second node N2. The power factor correction unit 131 may be an active power factor correction circuit, comprising a first diode D1, a third diode D3, a second inductor L2, a second capacitor C2, a second electrolytic capacitor EC2, a third switch Q3, and a fourth current-limiting resistor Rs4. In this embodiment, the third switch Q3 may be, but is not limited to, a MOSFET; in another embodiment, the third switch Q3 may also be a bipolar junction transistor (BJT) or other similar component. Unlike currently available power factor correction circuits, the power factor correction unit 131 further includes a first protection element 1311, which includes a fuse Fs1. The connections of the circuit components in the power factor correction unit 131 are shown in FIG. 2. The voltage conversion unit 132 is also connected to the first node N1 and the second node N2. The voltage conversion unit 132 includes a second diode D2, a first electrolytic capacitor EC1, a first inductor L1, a fourth switch Q4, and a third current-limiting resistor Rs3. In this embodiment, the fourth switch Q4 may be, but is not limited to, a MOSFET; in another embodiment, the fourth switch Q4 may also be a BJT or other similar component. Unlike currently available voltage converters, the voltage conversion unit 132 further includes a second protection element 1321, which includes a fuse Fs2. The connections of the circuit components in the voltage conversion unit 132 are shown in FIG. 2.

The detection module 14 includes a first detection unit 141 and a second detection unit 142. The first detection unit 141 is connected to the second node N2 and the first node N1. The first detection unit 141 includes a control switch U1, a fourth resistor R4, and an eighth resistor R8. In this embodiment, the control switch U1 may be, but is not limited to, a MOSFET; in another embodiment, the control switch U1 may also be a BJT or other similar component. The connections of the circuit components in the first detection unit 141 are shown in FIG. 2.

The second detection unit 142 is connected to the first node N1 and the voltage conversion unit 132. The second detection unit 142 includes a second current-limiting resistor Rs2, a seventh diode D7, a first capacitor C1, and a fifth switch Q5. In this embodiment, the fifth switch Q5 may be, but is not limited to, a BJT; in another embodiment, the fifth switch Q5 may also be a MOSFET or other similar component. The connections of the circuit components in the second detection unit 142 are shown in FIG. 2.

The control module 15 includes a backup power unit 151. The backup power unit 151 may be an internal circuit module or an independent circuit module within the control module 15. The control module 15 is connected to the backup power unit 151, the first detection module 141, the second detection module 142, and the first node N1. The control module 15 includes a first resistor R1, a second resistor R2, a third resistor R3, a fifth resistor R5, a sixth resistor R6, a seventh resistor R7, a first switch Q1, a second switch Q2, a fourth diode D4, and a sixth diode D6. In this embodiment, the first switch Q1 may be, but is not limited to, a MOSFET; in another embodiment, the first switch Q1 may also be a BJT or other similar component. Similarly, the second switch Q2 may be, but is not limited to, a BJT; in another embodiment, the second switch Q2 may also be a MOSFET or other similar component.

The backup power unit 151 is connected to the first node N1 and includes a first current-limiting resistor Rs1, a fifth current-limiting resistor Rs5, a sixth current-limiting resistor Rs6, a seventh current-limiting resistor Rs7, a fifth diode D5, an eighth diode D8, a sixth switch Q6, a seventh switch Q7, an eighth switch Q8, and a ninth switch Q9. The sixth switch Q6, the seventh switch Q7, the eighth switch Q8, and the ninth switch Q9 may be, but are not limited to, BJTs; in another embodiment, these switches may also be MOSFETs or other similar components.

The light source module 16 includes a main light source 160, a first backup light source 161, and a second backup light source 162, connected in series. The main light source 160 includes a plurality of main light-emitting diodes LD connected in series. The first backup light source 161 includes a plurality of first light-emitting diodes LD1 connected in series. The second backup light source 162 includes a plurality of second light-emitting diodes LD2 connected in series. The structures of the main light source 160, the first backup light source 161, and the second backup light source 162 may be adjusted as required. The main light source 160 is connected to the second node N2, the voltage conversion unit 132, and the first backup light source 161. The first backup light source 161 is connected to the second backup light source 162. The second backup light source 162 is connected to the control module 15.

The described circuit structures of each module are only examples and may vary according to actual requirements, without limiting the invention.

When the first detection unit 141 detects that the power factor correction unit 131 is normal and the second detection unit 142 detects that the voltage conversion unit 132 is also normal, the control module 15 does not activate the backup power unit 151. At this time, the power supply module 13 operates normally, and the rectification module 12 receives an input voltage from the external power source via the input module 11 to generate a rectified voltage, which is supplied to the light source module 16 via the two-stage circuit of the power supply module 13. During this state, only the main light source 160 is activated. The voltage of the main light source 160 is Va, and its current is Ia. The load voltage of the main light source 160 approximates the voltage of the main output wire of the rectification module 12, effectively reducing circuit loss. The total output power is substantially equal to the preset power, ensuring constant output power of the lighting device 1.

When the power factor correction unit 131 malfunctions, the first protection element 1311 enters the disconnected state, and the first detection unit 141 can detect that the power factor correction unit 131 has entered an abnormal state. When the power factor correction unit 131 is abnormal and the voltage conversion unit 132 is normal, the control module 15 does not activate the backup power unit 151. At this time, the power supply module 13 operates as a low power factor single-stage buck circuit, and the voltage conversion unit 132 drives the main light source 160. If the voltage (load voltage) of the main light source 160 is less than the voltage of the main output wire of the rectification module 12, the voltage of the main light source 160 is Va and the current is Ia, making the total output power essentially equal to the preset power. In this way, the lighting device 1 can maintain a constant output power.

However, if the voltage (load voltage) of the main light source 160 is greater than the voltage of the main output wire of the rectification module 12, both the power factor correction unit 131 and the voltage conversion unit 132 are abnormal. Therefore, the first protection element 1311 and the second protection element 1321 both enter the disconnected state, and the first detection unit 141 and the second detection unit 142 can detect that both the power factor correction unit 131 and the voltage conversion unit 132 are abnormal. At this point, no current flows through the second current-limiting resistor RS2; the fifth switch Q5 is off; the second switch Q2 is off; the ninth switch Q9 and the seventh switch Q7 are on, so that the base currents of the ninth switch 09 and the seventh switch Q7 counteract each other, reaching a steady state to achieve current limiting. In this case, the voltage of the main output wire of the rectification module 12 is lower than the reference threshold voltage of the control switch U1; the control switch U1 is off; the sixth switch Q6 and the eighth switch Q8 are off; the first diode D1 is on. The ninth switch Q9 and the seventh switch Q7 form a constant-current circuit. Additionally, the first current-limiting resistor Rs1, the fifth current-limiting resistor Rs5, the sixth current-limiting resistor Rs6, and the seventh current-limiting resistor Rs7 are connected in parallel through the sixth switch Q6 and the eighth switch Q8, reducing the resistance and increasing the output current, allowing the backup power unit 151 to provide both the power factor correction circuit and the buck circuit functionality. In this situation, the main light source 160 and the first backup light source 161 are in the active state. The voltage of the main light source 160 is Va, and the current of the main light source 160 is Ia. The voltage of the first backup light source 161 is Vb, and the current of the first backup light source 161 is Ib. Through appropriate load design, the load voltage Vp is effectively equal to the combined voltage (Va+Vb) of the main light source 160 and the first backup light source 161, approaching the voltage of the main output wire of the rectification module 12. In this way, circuit losses can be effectively reduced, and the total output power is substantially equal to the preset power. Thus, the lighting device 1 can maintain constant output power.

When the voltage conversion unit 132 is abnormal, the second protection element 1321 enters the disconnected state, and the second detection unit 142 can detect that the voltage conversion unit 132 has entered an abnormal state. When the power factor correction unit 131 is normal and the voltage conversion unit 132 is abnormal, the control module 15 activates the backup power unit 151. At this time, no current flows through the second current-limiting resistor RS2; the fifth switch Q5 and the second switch Q2 are off; the ninth switch Q9 and the seventh switch Q7 are on, so that the base currents of the ninth switch Q9 and the seventh switch Q7 counteract each other, reaching a steady state to achieve current limiting. The power factor correction unit 131 operates normally, and the voltage of the main output wire of the rectification module 12 is greater than the reference threshold voltage of the control switch U1; the control switch U1 is on; the first switch Q1 is off; the sixth switch Q6 and the eighth switch Q8 are off; the first diode D1 is off. The ninth switch Q9 and the seventh switch Q7 form a constant-current circuit. Additionally, the fifth diode D5, the eighth diode D8, the first current-limiting resistor Rs1, the fifth current-limiting resistor Rs5, the sixth current-limiting resistor Rs6, and the seventh current-limiting resistor Rs7 are used to achieve dynamic constant current, allowing the backup power unit 151 to provide the functionality of the buck circuit. In this situation, the main light source 160, the first backup light source 161, and the second backup light source 162 are in the active state. The voltage of the main light source 160 is Va, and the current of the main light source 160 is Ia. The voltage of the first backup light source 161 is Vb, and the current of the first backup light source 161 is Ib. The voltage of the second backup light source 162 is Vc, and the current of the second backup light source 162 is Ic. Through appropriate load design, the load voltage Vp is effectively equal to the combined voltage (Va+Vb+Vc) of the main light source 160, the first backup light source 161, and the second backup light source 162, approaching the bus voltage of the rectification module 12. In this way, circuit losses can be effectively reduced, and the total output power is substantially equal to the preset power. Thus, the lighting device 1 can maintain constant output power.

As seen above, the control module 15 can appropriately control the backup power unit 151 based on the operating state of the power supply module 13 and selectively drive the main light source 160, the first backup light source 161, and the second backup light source 162 to make the load voltage approach the voltage of the main output wire of the rectification module 12. Additionally, the backup power unit 151 can appropriately provide the functionality of the power factor correction circuit and/or the buck circuit. In this way, the lighting device 1 can maintain constant output power, significantly improving the reliability of the lighting device 1.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the present invention, one embodiment of the present invention, the lighting device includes a light source module, a rectification module, a power supply module, a detection module and a control module. The rectification module generates a rectified voltage. The power supply module is connected to the rectification module and the light source module, and includes a power factor correction unit and a voltage conversion unit. The power supply module receives the rectified voltage to generate a driving voltage so as to drive the light source module. The detection module is connected to the power supply module, and includes a first detection unit for detecting the power factor correction unit and a second detection unit for detecting the voltage conversion unit. The control module is connected to the detection module, and includes a backup power unit. The control module controls the backup power unit according to the detection result of the first detection unit and the second detection unit. Via the above-mentioned adaptive adjustment mechanism, the lighting device can maintain a constant output power even in the event of a power supply module malfunction, thereby reducing the failure rate of the lighting device. As a result, the reliability of the lighting device can be effectively improved so as to meet actual requirements.

According to one embodiment of the present invention, the light source module includes a main light source, a first backup light source, and a second backup light source. The control module can detect the operational status of the power factor correction unit via the first detection unit and detect the operational status of the voltage conversion unit via the second detection unit. Then, the control module can control the backup power unit according to the detection results of the first detection unit and the second detection unit in order to selectively drive one or more of the main light source, the first backup light source, and the second backup light source. The above-mentioned adaptive adjustment mechanism can ensure constant output power via a simple operational mechanism. Consequently, the circuit complexity of the lighting device can be effectively reduced.

Also, according to one embodiment of the present invention, the lighting device can ensure constant output power through a simple and effective adaptive adjustment mechanism, thereby significantly improving the reliability of the lighting device and greatly reducing its circuit complexity. As a result, the maintenance cost of the lighting device can be substantially reduced, such that the lighting device can conform to the requirements of different applications.

Further, according to one embodiment of the present invention, the adaptive adjustment mechanism of the lighting device can be applied to the circuit design of currently available lighting devices, thus achieving high compatibility. Additionally, the adaptive adjustment mechanism of the lighting device can be implemented without increasing the size of the electronic components. As a result, the development cost of the lighting device can also be effectively reduced.

Moreover, according to one embodiment of the present invention, the adaptive adjustment mechanism of the lighting device can selectively drive one or more of the main light source, the first backup light source, and the second backup light source according to the operational status of the power supply module. Thus, with appropriate load design, the lighting device can maintain constant output power to achieve high operational efficiency. As a result, the lighting device can be more energy-efficient, which can align with environmental protection needs.

Furthermore, according to one embodiment of the present invention, the lighting device can achieve the desired functionality without significantly increasing costs and can effectively address the shortcomings of currently available technologies. Therefore, the lighting device can achieve high practicality in order to meet the needs of different users.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lighting device with an adaptive adjustment mechanism, comprising:
a light source module;
a rectification module configured to generate a rectified voltage;
a power supply module connected to the rectification module and the light source module, and comprising a power factor correction unit and a voltage conversion unit, wherein the power supply module is configured to receive the rectified voltage to generate a driving voltage so as to drive the light source module;
a detection module connected to the power supply module, and comprising a first detection unit configured to detect the power factor correction unit and a second detection unit configured to detect the voltage conversion unit; and
a control module connected to the detection module, and comprising a backup power unit, wherein the control module controls the backup power unit according to a detection result of the first detection unit and a detection result of the second detection unit.

2. The lighting device with the adaptive adjustment mechanism as claimed in claim 1, wherein the control module activates the backup power unit to drive the light source module when the second detection unit detects that the voltage conversion unit is abnormal.

3. The lighting device with the adaptive adjustment mechanism as claimed in claim 1, wherein the light source module comprises a main light source, a first backup light source, and a second backup light source.

4. The lighting device with the adaptive adjustment mechanism as claimed in claim 3, wherein the control module does not activate the backup power unit when the first detection unit detects that the power factor correction unit is normal and the second detection unit detects that the voltage conversion unit is normal, and drives the main light source via the power factor correction unit and the voltage conversion unit.

5. The lighting device with the adaptive adjustment mechanism as claimed in claim 3, wherein the control module does not activate the backup power unit when the first detection unit detects that the power factor correction unit is abnormal and the second detection unit detects that the voltage conversion unit is normal, and drives the main light source via the voltage conversion unit.

6. The lighting device with the adaptive adjustment mechanism as claimed in claim 3, wherein the control module activates the backup power unit when the first detection unit detects that the power factor correction unit is normal and the second detection unit detects that the voltage conversion unit is abnormal, and drives the main light source, the first backup light source, and the second backup light source via the voltage conversion unit and the backup power unit.

7. The lighting device with the adaptive adjustment mechanism as claimed in claim 3, wherein the control module activates the backup power unit when the first detection unit detect that the power factor correction unit is abnormal and the second detection unit detects that the voltage conversion unit is abnormal, and drives the main light source and the first backup light source via the backup power unit.

8. The lighting device with the adaptive adjustment mechanism as claimed in claim 1, wherein the power factor correction unit comprises a first protection element, and the first protection element enters a disconnected state when the power factor correction unit is abnormal.

9. The lighting device with the adaptive adjustment mechanism as claimed in claim 8, wherein the voltage conversion unit comprises a second protection element, and the second protection element enters the disconnected state when the voltage conversion unit is abnormal.

10. The lighting device with the adaptive adjustment mechanism as claimed in claim 8, wherein the first protection element and the second protection element are fuses.
